(19) United States
(12) Patent Application Publication
(10) Pub. No.: US 2003/0003217 A1
(43) Pub. Date: Jan. 2, 2003

(54) Rice pudding method and composition

(76) Inventor: Donald Bruce Budinoff, Farmingdale, NY (US)

Correspondence Address: ARLEN L. OLSEN, SCHMEISER, OLSEN & WATTS, 3 LEAR JET LANE, SUITE 201, LATHAM, NY, 12110, US

(21) Appl. No.: 10/035,756

(22) Filed: Dec. 31, 2001

Related U.S. Application Data
(60) Provisional application No. 60/301,522, filed on Jun. 28, 2001.

(51) Int. Cl. A23L 1/168

(52) U.S. Cl. 426/618

(57) ABSTRACT

A method and composition for aseptically producing rice pudding. The method 10 for aseptically preparing a rice pudding, comprising the following steps: step 31, forming a mixture, wherein the mixture includes a pre-broken rice; step 37, hydrating the rice; and step 38, aseptically processing the mixture. A rice pudding, comprising: an aseptically processed mixture; and a hydrated rice, wherein the rice includes pre-broken rice.

### BACKGROUND OF THE INVENTION

1. Technical Field

The present invention relates generally to methods for aseptically processing rice products, compositions of rice products, and a composition of rice products. More specifically, the present invention relates to methods for aseptically processing rice pudding and aseptic compositions of rice puddings.

2. Related Art

During a conventional preparation of rice pudding starch is cooked out of rice grains by heating the rice grains in the presence of an assortment of ingredients such as milk products, egg, flavoring and coloring. This results in softening the rice for consumption, and also in creating a desirable texture and consistency because starch serves to thicken the pudding. Conventional processes require careful stirring of the rice pudding during the heating process to avoid scalding the pudding.

In U.S. Pat. No. 4,585,664, Kohlwey disclosed use of whole grains and broken grains of rice for preparation of a dry instant rice porridge mix. Kohlwey disclosed the rice may be instantized by employing a process similar to that disclosed by Hollis et al. in U.S. Pat. No. 2,828,209. The dry instant porridge mix may be added to milk, brought to a boil with stirring, removed from heat, and eaten after sanding for about five (5) minutes.

There is a need for an aseptic process for preparing rice pudding that reduces the potential for scalding the rice pudding. There is also a need for an aseptically produced rice pudding.

### SUMMARY OF THE INVENTION

The present invention provides a method for preparing a rice pudding, comprising:

forming a mixture, wherein the mixture includes a pre-broken rice;

hydrating the rice; and

aseptically processing the mixture.

A second embodiment of the present invention provides a rice pudding, comprising:

an aseptic mixture, wherein the mixture includes a hydrated rice; and wherein the rice includes a pre-broken rice.

A third embodiment of the present invention provides a rice pudding, comprising:

an aseptic mixture selected from the group consisting of from about 65.0 to about 75.0 percent by weight whole milk, from about 13.0 to about 17.0 percent by weight liquid sugar, from about 7.0 to about 9.0 percent by weight of a rice selected from the group consisting of whole grain rice, pre-broken rice and combinations thereof, and from about 0.5 to about 1.0 percent by weight starch.

### BRIEF DESCRIPTION OF THE DRAWINGS

FIG. 1 depicts a method for aseptically preparing rice pudding, according to embodiments of the present invention;

FIG. 2 depicts a product tank for forming a blend of a portion of the rice pudding, according to embodiments of the present invention;

FIG. 3 depicts a product tank for forming a mixture of the blend and a rice, according to embodiments of the present invention.

FIG. 4 depicts a cross-sectional view of a hydration tube, equipped for aseptically processing a rice pudding, according to embodiments of the present invention;

FIG. 5 depicts a longitudinal cross-sectional view of the hydration tube of FIG. 4, equipped for aseptically processing the rice pudding;

FIG. 6 depicts a cross-sectional view of a holding tube, equipped for aseptically processing the rice pudding, according to embodiments of the present invention; and

FIG. 7 depicts a longitudinal cross-sectional view of the holding tube of FIG. 6, equipped for aseptically processing the rice pudding.

### DETAILED DESCRIPTION OF THE PREFERRED EMBODIMENTS

Although certain preferred embodiments of the present invention will be shown and described in detail, it should be understood that various changes and modifications may be made without departing from the scope of the appended claims. The scope of the present invention will in no way be limited to the number of constituting components, the materials thereof, the shapes thereof, the relative arrangement thereof, etc., and are disclosed simply as an example of the preferred embodiment. The features and advantages of the present invention are illustrated in detail in the accompanying drawings, wherein like reference numerals refer to like elements throughout the drawings. Although the drawings are intended to illustrate the present invention, the drawings are not necessarily drawn to scale.

In the food industry, the terms aseptic, sterile and commercially sterile are often used interchangeably. For the rice pudding of the present invention, it is important to know that the rice pudding may be processed aseptically but may not be packaged aseptically so it may not remain aseptic. The term “aseptic” is defined as “substantially free from disease, fermentation or putrefaction.” Hereinafter “aseptic method or aseptic process” or “process for preparing the rice pudding aseptically” or “processed aseptically” refer to a process or method for substantially freeing food from disease, fermentation or putrefaction

A standard ultra-high-temperature extended-shelf-life (UHT ESL) method for making rice pudding aseptically may include heating the rice pudding from about 270 ° F. to about 290 ° F. for holding times at least from about 15 to about 30 seconds. Hereinafter “ultra-high-temperature extended-shelf-life (UHT ESL)” means subjecting the pudding to high temperature and short residence time to aseptically produce rice pudding without making certain quality attributes unacceptable. The UHT ESL aseptic process for preparing the rice pudding of the present invention may satisfy a 1999 United States Public Health Service/Food and Drug Administration Pasteurized Milk Ordinance (Pasteurized Milk Ordinance, Public Health Service/Food and Drug Administration Publication No. 229, 1999) governing preparation of pudding as long as the pudding is not held to be shelf-stable, since the disclosed pudding may not be aseptically packaged.

A purpose of the present invention is to make the rice pudding aseptic using the high temperature and short time processing without causing the rice pudding to have unacceptable quality attributes. Hereinafter “acceptable quality attributes” refer to the rice pudding having acceptable texture, flavor, smoothness, color, sweetness, aftertaste, and “unacceptable quality attributes” refer to the rice pudding having unacceptable texture, flavor, smoothness, color, sweetness, aftertaste. Another important quality attribute may be that the rice becomes sufficiently hydrated by the high temperature and short time processing of the rice in the rice pudding that the rice may not be too hard to chew, yet not so soft after being subjected to high temperature and short time processing that the rice has lost piece integrity. Hereinafter, retaining “piece integrity” means after being subjected to high temperature and short time processing that the rice may not be too hard to chew, or alternatively, be too soft so that it can be deformed by a human mouth without chewing. Food companies may utilize professional taste testers who have tasted acceptable and unacceptable rice pudding, wherein the taste testers may be able to distinguish whether the rice pudding has acceptable or unacceptable quality attributes. The rice in the rice pudding having acceptable quality piece integrity may lose this acceptable quality attribute if the rice becomes dry or brittle as the pudding ages.

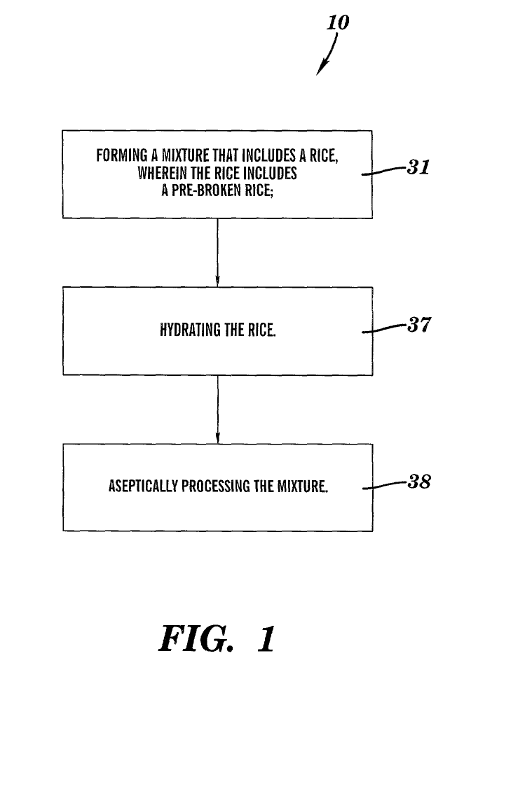

FIG. 1 depicts a method 10 for aseptically preparing a rice pudding, comprising the following steps: step 31, forming a mixture that includes a rice, wherein the rice includes a pre-broken rice; step 37, hydrating the rice; and step 38, aseptically processing the mixture.

Referring to FIG. 1, the rice of the step 37 of the method 10 may comprise a mixture of a whole grain and a pre-broken rice. In an embodiment, the rice may comprise from about 60 to about 80 percent by weight the broken rice and from about 20 to about 40 percent by weight the whole grain rice. Alternatively the rice may be a commercially available instant rice IM 75 comprising 75 percent by weight broken rice and 25 percent by weight whole grain rice.

Referring to FIG. 1, the mixture of the step 31 of the method 10 may further comprise a milk from about 66.3 to about 77.6 percent by weight of the rice pudding and includes whole milk, 40% Butter Fat Cream, skim milk and dry milk products such as non-fat dry milk. Alternatively, a milk substitute such as sodium caseinate may be used.

Referring to FIG. 1, the mixture of the step 31 of the method 10 may further comprise a sugar from about 13.5 to about 17.1 percent by weight of the rice pudding and includes liquid sugar, sugared egg yolk, confectioners sugar and any alternative forms of sugar such as granular sugar. Alternatively, sugar substitutes such as saccharine or aspartamene may be used.

Referring to FIG. 1, the mixture of the step 31 of the method 10 may further comprise a starch from about 0.5 to about 1.0 percent by weight of the rice pudding and include rice starch. Alternatively, the starch of the step 31 of the method 10 may be purified starch from potato, cassava, tapioca, yucca, corn, wheat, modified starches such as pre-gelatinized, oxidized, acetylated, cationic or anionic starch. Purification of the starch may be done by extracting the starch using hot water or steam, then drying the starch to obtain purified starch.

Referring to FIG. 1, the mixture of the step 31 of the method 10 may further comprise a stabilizing agent from about 0.1 to about 0.3 percent by weight of the rice pudding and includes Kapa Carrageenan, a polysaccharide sea weed extract made up of repeating galactose units linked with alternating alpha 1-3, and beta 1-4 glycosidic linkages. In addition, the galactose units in this general structure often occur as 3,6-anhydro-D-galactose and sulfate esters may also be present on some galactose units. Kappa, iota and lambda types of carrageenan, know as kapa, iota and lambda are approved for use in food and may be used as stabilizing agents in the forming the mixture step 31 of the method 10. The primary differences which influence the properties of carrageenan are numbers and position of the ester sulfate groups on the repeating galactose units.

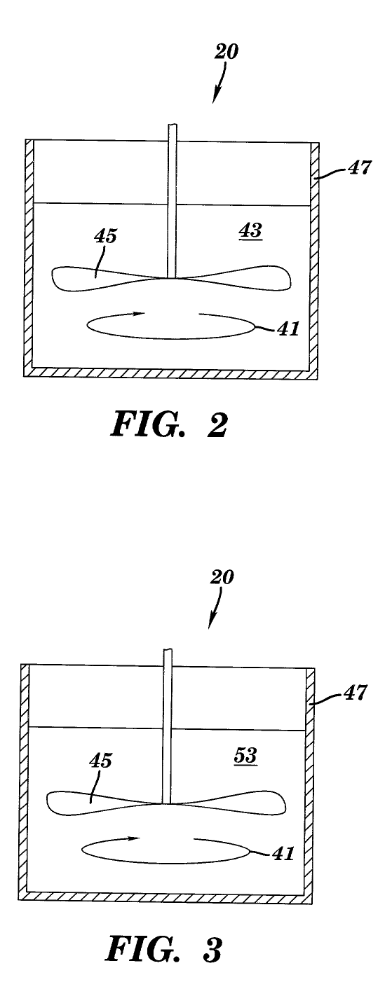

FIG. 2 depicts an apparatus 20 after forming the mixture 43 that includes the milk, the sugar; the starch; and the stabilizing agent; according to the step 31 of the method 10. Referring to FIG. 2, the apparatus 20 may be a product tank 20 or any appropriate container 20, comprising a wall 47 and an agitator 45. Referring to FIG. 2, the blend 43 may have been formed by adding the milk, the sugar; the starch; and the stabilizing agent to the apparatus 20 according to the step 31 of the method 10, and rotating the agitator 45 in a direction of an arrow 41 for from about 5 to about 60 minutes.

Alternatively, referring to FIG. 2, the blend 43 may be homogenized at 1500 psi single stage. Hereinafter, the blend 43 may be homogenized single stage by passing the blend 43 at a flow rate from about 20 gallons per minute (gpm) to about 40 gpm under a pressure from about 1,000 to about 2,500 psi through a homogenizer valve.

Referring to FIGS. 1-2, in an embodiment of the present invention, in the step 31 of the method 10, the milk may be added to the apparatus 20, and warmed from about 40 ° F. to about 140° F., followed by addition of the sugar; the starch; and the stabilizing agent to the apparatus 20, and rotating the agitator 45 in a direction of an arrow 41 for from about 5 to about 60 minutes.

Referring to FIGS. 1-2, the blend 43 of the step 31 of the method 10 may further comprise a flavoring agent from about 0 to about 0.485 percent by weight of the rice pudding and include salt, vanilla custard, tetra sodium pyrophosphate and egg enhancing flavor.

Referring to FIGS. 1-2, the blend 43 of the step 31 of the method 10 may further comprise a coloring agent that includes TiO₂ and may be from about 0 to about 0.1 percent by weight of the rice pudding.

FIG. 3 depicts FIG. 2 after forming a mixture 53 by adding the rice to the blend 43 in the apparatus 20 and rotating the agitator 45 in the direction of the arrow 41 for from about 5 to about 60 minutes, according to the step 31 of the method 10. Referring to FIG. 3, an ingredient feeder such as a silo, equipped with a feeder or other appropriate storage and feeding device may be used to add rice to the blend 43.

Referring to FIG. 3, in an embodiment in which the blend 43 may have undergone homogenization, such as for example single stage homogenization, the blend 43 may be cooled in the apparatus 20, equipped with the agitator 45 of the apparatus 20. Alternatively, the blend 43 may be cooled by circulating the blend 43 through a tubular and/or scraped surface heat exchanger. Alternatively, the blend 43 may be cooled by passing the blend 43 through a cooling tunnel. In an embodiment of the present invention, circulating the blend 43 through a tubular and/or scraped surface heat exchanger cooled the blend 43 from 45 ° F. to about 35 ° F.

Referring to FIG. 1, according to the step 37 of the method 10, numerous trial runs were conducted to effectively hydrate the rice so that it will have piece integrity after aseptic processing. Hereinafter, the high temperature and short time processing may “effectively hydrate” the rice in the rice pudding when the rice in the rice pudding that results from the aseptic processing of the rice pudding has piece integrity.

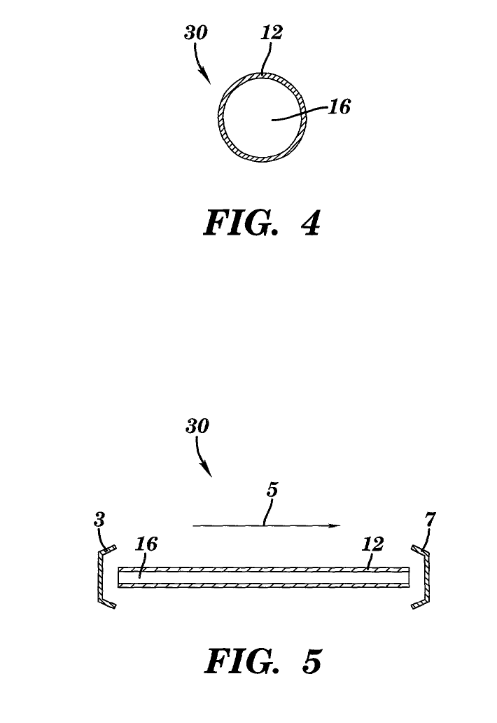

FIG. 4 depicts a cross-sectional view of an apparatus 30 for effectively hydrating the rice in the rice pudding, according to the step 37 of the method 10, as depicted in FIG. 1, and associated text supra. The apparatus 30 may be a hydration tube 30, comprising: an outer wall 12; and an open bore 16. The apparatus 30 may be equipped for heating from ambient to a temperature from about 170 ° F. to about 250 ° F. The apparatus 30 may be made from any of a variety of stainless steel materials or alternative materials capable of containing a rice pudding at a temperature range from about 170 ° F. to about 250 ° F. and at pressures from 0 to 1,500 psi without undergoing corrosion or rupture.

FIG. 5 depicts a longitudinal cross-section of the apparatus 30, wherein the mixture 53 of the homogenized blend 43 and the rice of the present invention is introduced into the apparatus 30, in a direction of an arrow 5. Referring to FIG. 5, the mixture 53 may be pre-heated using tubular and scrape surface heat exchanges from about 40 ° F. to about 250 ° F.

Referring to FIG. 5, a purpose of passing the mixture 53 of the homogenized blend 43 and the rice through the apparatus 30 may be to effectively hydrate the rice. Hereinafter, a “residence time” is a length of time the mixture 53, comprising: the rice; and the blend 43, remains in the apparatus 30 and may be heated from about 170 ° F. to about 250 ° F., resulting in the rice pudding having effectively hydrated rice. The residence time of the mixture 53 of the homogenized blend 43 and the rice in the apparatus 30 may be increased by increasing either a length or a diameter of the apparatus 30, without changing a flow rate of the mixture 53 through the apparatus 30. Alternatively the residence time of the mixture 53 of the homogenized blend 43 and the rice in the apparatus 30 may be decreased by decreasing the length or the diameter of the apparatus 30, without changing a flow rate of the mixture 53 through the apparatus 30. Another method of reducing the residence time in the apparatus 30 may be to increase a flow rate of the mixture 53 of the homogenized blend 43 and the rice through the apparatus 30, without changing the diameter and length of the apparatus 30. Alternatively, the residence time in the apparatus 30 may be increased by reducing the flow rate of the mixture 53 of the homogenized blend 43 and the rice in the apparatus 30, without changing the diameter and length of the apparatus Increasing the rate would reduce this critical residence time. Referring to FIG. 5, in order to achieve the residence time of from about 60 to about 360 seconds, one skilled in the art may determine the residence time of the rice pudding in the apparatus 30 by injecting a colored dye that may be detected by the human eye into the proximal end 3 of the apparatus 30 and measuring a difference in time between when the dye was injected to when it appeared at the distal end 7 of the apparatus 30. The difference in time (ΔT) is the residence time of the rice pudding for the flow rate of the rice pudding used during the determination of the residence time ΔT. Alternatively, moisture and temperature sensors could be placed in the mixture 53 to obtain a moisture and a thermal history of the mixture 53.

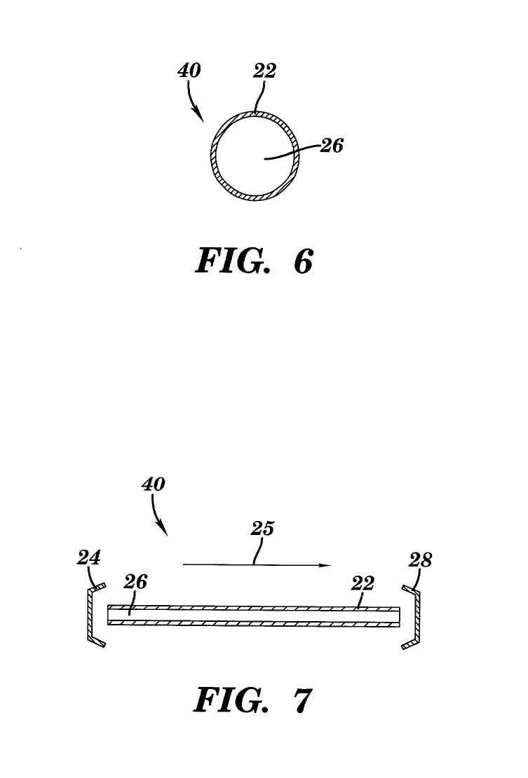

FIG. 6 depicts a cross-sectional view of the an apparatus 40, further comprising an outer wall 22 and an open bore 26, according to the step 38 of the method 10, as depicted in FIG. 1 and described in associated text supra. Referring to FIG. 6, the apparatus 40 may be a holding tube 40 and may be equipped for heating from ambient to a temperature from about 270 ° F. to about 290 ° F. Referring to FIG. 6, the apparatus 40 may be made from any of a variety of Stainless Steel materials or alternative materials capable of containing a rice pudding in a temperature range from about 270 ° F. to about 290 ° F. at pressures from 0 to 1500 psi without undergoing corrosion or rupture of the apparatus 40.

Referring to FIG. 1, in an embodiment of the present invention, according to the steps the Method 10, with the use of IM 75 Instant Rice mixture of whole rice and pre-broken rice, we determined that the added starch concentration could be reduced substantially from typical starch levels in aseptically (UHT ESL) processed pudding made from whole grain rice alone. Referring to FIG. 1, this is due to an added exposed surface area of the pre-broken rice in the IM 75 Instant Rice blend compared to the surface area of whole grain rice, which allows more starch to be extracted during the aseptic processing according to the steps of the method 10 because pre-broken rice has more surface area than whole grain rice.

FIG. 7 depicts a longitudinal cross-section of the apparatus 40, wherein the mixture 53, as depicted in FIG. 3, may be passed through the apparatus 40, in a direction of an arrow 25., according to the step 38 of the method 10, as depicted in FIG. 1 and described in associated text supra. Referring to FIGS. 4-7, in an embodiment of the present invention, the mixture 53 may be heated from about 250° F. to about 280° F. using tubular and/or scrape surface heat exchangers placed in line between the distal end 7 of the apparatus 20 and the proximal end 24 of the apparatus 40. The apparatus 40 is sized such that the rice pudding may have a residence time of from about 15 to about 30 seconds. The residence time of the mixture 53 in the apparatus 40 may be increased by increasing either a length or a diameter of the apparatus 40, without changing the flow rate of the mixture 53 through the apparatus 40. Alternatively the residence time of the mixture 53 in the apparatus 40 may be decreased by decreasing the length or the diameter of the apparatus 40, without changing the flow rate of the mixture 53 through the apparatus 40. Another method of reducing the residence time in the apparatus 40 may be to increase the flow rate of the mixture 53, without changing either a diameter or a length of the apparatus 40. Alternatively, the residence time in the apparatus 40 may be increased by reducing the flow rate of the mixture 53 in the apparatus 40, without changing either the diameter or the length of the apparatus 40.

Referring to FIG. 7, in order to achieve the residence time of from about 15 to about 30 seconds, one skilled in the art may determine the residence time of the rice pudding in the apparatus 40 by injecting a colored dye that may be detected by the human eye into the proximal end 24 of the apparatus 40 and measuring a difference in time between when the dye was injected to when it appeared at the distal end 28 of the apparatus 40. The difference in time (ΔT) is the residence time of the rice pudding for the flow rate of the rice pudding used during the determination of the residence time ΔT. Alternatively, moisture and temperature sensors could be placed in the mixture 53 to obtain a moisture and thermal history of the mixture 53.

Referring to FIGS. 4-7, the aseptically processed rice pudding of the present invention may be cooled as it emerges from the distal end 28 of the apparatus 40. For example, the aseptically processed rice pudding of the present invention may be cooled from about 280° F. to between about 50° F. and 60° F. by circulating it through a tubular and/or a scraped surface heat exchanger. The cooled aseptically processed rice pudding may be collected in an aseptic surge tank as it emerges from the tubular and/or a scraped surface heat exchanger. The aseptically processed pudding of the present invention may be aseptically fed to a commercially available ultra-clean sterilized filler for filling final containers with the aseptically processed rice pudding. Hereinafter, “filling” refers to a process of transferring the aseptically processed rice pudding of the present invention into final containers, using an aseptic ultra-clean sterilized filler. After filling, the aseptically processed rice pudding may be further cooled from about 50° F. to about 40° F. using a cooling tunnel.

Referring to FIGS. 1-7, the following example is provided to further describe the preferred embodiments of the present invention, in particular, examples of methods for aseptically processing rice pudding and examples of the various rice pudding compositions described herein:

Example (All % Are Percent by Weight):

Referring to FIG. 2 and the step 31 of the method 10 as depicted in FIG. 1, the blend 43 of a portion of the rice pudding was mixed in the product tank 20, equipped with the agitator 45, by adding the following to the product tank 20 and after completion of the addition, mixing for fifteen (15) minutes using the agitator 45 of the product tank 20:

Whole Milk 65.0-75.00%;

Liquid Sugar 13.00-17.00%;

40% Butter Fat Cream 1.00-2.00%;

Rice Starch 0.50-1.00%;

Sugared Egg Yolk 0.50-1.00%;

Non Fat Dry Milk 0.30-0.60%;

Carrageenan(Kappa) 0.10-0.30%;

Salt 0.1500%;

Vanilla Flavor 0.1500%;

Color 0.1000%;

Custard Flavor 0.0100%;

TetraSodiumPyrophosphate 0.01-0.10%; and

Egg Enhancing Flavor 0.0250%.

Referring to FIGS. 1-3, the blend 43 of the portion of the aseptically processed rice pudding in the product tank 20, was homogenized at 1500 psi single stage, and the homogenate was cooled to about 40 ° F. and collected in a product tank 20, equipped with an agitator 45. Referring to FIG. 3 and the step 31 of the method 10 as depicted in FIG. 1, Instant Rice IM 75 from about 7.00 to about 9.00% was added to the blend 43 in the product tank 20, with mixing using the agitator 45 to form mixture 53. The mixture 53 was pre-heated by circulating the mixture 53 through tubular and/or scrape surface heat exchangers from 40° F. to 250° F. Alternatively, the mixture 53 may be heated by the product tank 20 if the product tank 20 is equipped with a heated jacket. Referring to FIGS. 4-7, according to the step 37 of the method 10 as depicted in FIG. 1, the mixture 53 is aseptically processed by introducing the pre-heated mixture 53 into the hydration tube 30, wherein the residence time of the mixture 53 in the hydration tube 30 is at least 90 seconds, and the temperature of the mixture 53 in the hydration tube 30 is from about 170° F. to about 250° F. Referring to FIGS. 4-7, hold the mixture 53 in the hydration tube 30 for at least 90 seconds at the temperature from about 170° F. to about 250° F. Referring to FIGS. 4-7, according to the step 38 of the method 10 as depicted in FIG. 1, the rice pudding is aseptically processed by passing the mixture 53 through the holding tube 40, wherein the apparatus tube 22 is heated by a scrape and/or surface heat exchanger to about 280° F., wherein the residence time of the mixture 53 in the apparatus 40 is at least 25 seconds. Referring to FIGS. 4-7, according to the step 38 of the method 10 as depicted in FIG. 1, the mixture 53 is held at 280° F. for 25 seconds in the holding tube 40. Referring to FIG. 7, the aseptically processed rice pudding of the present invention may be cooled from about 280° F. to between about 50° F. and 60° F. by circulating the aseptically processed rice pudding through a tubular and/or scraped surface heat exchanger as it emerges from the distal end 28 of the tube 40. The cooled aseptically processed rice pudding of the present invention may then be collected in an aseptic surge tank as it emerges from the tubular and/or a scraped surface heat exchanger. The aseptically processed pudding of the present invention may be aseptically fed to a commercially available ultra-clean sterilized filler for filling final containers with the aseptically processed rice pudding. Hereinafter, “filling” refers to a process of transferring the aseptically processed rice pudding of the present invention into final containers, using an asceptic ultra-clean sterilized filler. After filling, the aseptically processed rice pudding may be further cooled from about 50° F. to about 40° F. using a cooling tunnel.

The foregoing description of the embodiments of this invention has been presented for purposes of illustration and description. It is not intended to be exhaustive or to limit the invention to the precise form disclosed, and obviously, many modifications and variations are possible. Such modifications and variations that may be apparent to a person skilled in the art are intended to be included within the scope of this invention as defined by the accompanying claims.

I claim:

1. A method for preparing a rice pudding, comprising:
forming a mixture, wherein the mixture includes a pre-broken rice;
hydrating the rice; and
aseptically processing the mixture.

2. The method of claim 1, wherein a starch in the forming the mixture step includes rice starch.

3. The method of claim 1, wherein the step of forming a mixture further comprises adding an additive selected from the group consisting of a milk, a sugar, a starch, a stabilizing agent and combinations thereof.

4. The method of claim 3, wherein the step of forming a mixture further comprises adding an additive selected from the group consisting of a salt, a sugared egg yolk, tetra sodium pyrophosphate, a flavoring agent a coloring agent and combinations thereof.

5. The method of claim 1, wherein the stabilizing agent includes carrageenan.

6. The method of claim 1, wherein the step of forming a blend further comprises homogenizing the blend at 1500 psi single stage.

7. The method of claim 1, wherein before adding the rice, the blend is cooled to from about 45° F. to about 35° F.

8. The method of claim 1, wherein the rice includes Instant Rice IM 75.

9. The method of claim 1, wherein the aseptically processing the mixture step further comprises:
providing a hydration tube and a holding tube; and
passing the mixture through the hydration tube and the holding tube.

10. The method of claim 9, wherein the prior to the passing the mixture through the hydration tube and the holding tube, the mixture is heated according to an ultra-high-temperature extended-shelf-life (UHT ESL) method.

11. The method of claim 9, wherein the passing the mixture step further comprises the mixture having a residence time in the hydration tube at least from about 60 to about 360 seconds.

12. The method of claim 9, wherein the passing the mixture step further comprises the mixture having a residence time in the holding tube at least 15-30 seconds.

13. The method of claim 9, wherein the step of forming a blend further comprises homogenizing the blend at 1500 psi single stage.

14. The method of claim 9, wherein prior to the passing the product through the hydration tube and the holding tube step the mixture is heated from about 270° F. to about 290° F.

15. The method of claim 1, wherein before the forming a mixture step, the blend is cooled to from about 45° F. to about 35° F.

16. The method of claim 1, wherein after the passing the mixture through the hydration tube and the hold tube step, cooling the mixture to a temperature from about 50° F. to about 60° F.

17. The method of claim 1, wherein the aseptically processed mixture has acceptable quality attributes.

18. A rice pudding, comprising:
an aseptic mixture, wherein the mixture includes a hydrated rice; and wherein the rice includes a pre-broken rice.

19. The rice pudding of claim 17, wherein the rice mixture is at least 75 percent by weight pre-broken rice.

20. A rice pudding, comprising:
an aseptic mixture selected from the group consisting of from about 65.0 to about 75.0 percent by weight whole milk, from about 13.0 to about 17.0 percent by weight liquid sugar, from about 7.0 to about 9.0 percent by weight of a rice selected from the group consisting of whole grain rice, pre-broken rice and combinations thereof, and from about 0.5 to about 1.0 percent by weight starch.
